(19) United States
(12) Patent Application Publication
(10) Pub. No.: US 2025/0153339 A1
(43) Pub. Date: May 15, 2025

(54) MODULAR COMPARTMENT ASSEMBLY AND METHOD OF USE

(71) Applicant: BHN Holding LLC, West Palm Beach, FL (US)

(72) Inventor: Joel Weiss, West Palm Beach, FL (US)

(73) Assignee: BHN Holding LLC, West Palm Beach, FL (US)

(21) Appl. No.: 18/389,372

(22) Filed: Nov. 14, 2023

(51) Int. Cl. B25H 3/02

(52) U.S. Cl. CPC B25H 3/023

(57) ABSTRACT

A modular compartment assembly comprising a base, a first sidewall, a second sidewall, a top wall situated parallel to the base, wherein the first sidewall is connected to the top wall at a first end of the top wall and the second sidewall is connected to the top wall at a second end of the top wall, the top wall comprising an activity mat, at least one mobility module located on a surface of the base and extending in a direction opposite of the first sidewall, a compartment area, wherein the compartment area is configured to receive at least one modular tool partition and at least one modular block located on an outer surface of the modular compartment assembly, the at least one modular block comprising at least one engagement feature removably attached to an outer surface of the modular compartment assembly.

### FIELD OF THE INVENTION

The present invention generally relates to the field of compartments. In particular, the present invention is directed to a modular compartment assembly.

### BACKGROUND

Compartments generally are configured for limited use. In addition, modular compartments configured for multiuse generally do not have configurable components that allow for use amongst a broad array of fields.

### SUMMARY OF THE DISCLOSURE

In an aspect a modular compartment assembly is described. The modular compartment assembly includes a base, a first sidewall located at a first end of the base and extending orthogonal to the base, a second sidewall located at a second end of the base and extending orthogonal to the base, wherein the first sidewall and the second sidewall are located on opposing ends of the base and a top wall situated parallel to the base, wherein the first sidewall is connected to the top wall at a first end and the second sidewall is connected to the top wall at a second end, the top wall having an activity mat. The modular compartment assembly further includes at least one mobility module located on a surface of the base and extending in a direction opposite the first sidewall, a compartment area, wherein the compartment is configured to receive at least one modular tool partition and at least one modular block located on an outer surface of the modular compartment assembly, the at least one modular block having at least one engagement feature and wherein the at least one modular block is removably attached to the outer surface of the modular compartment assembly.

In another aspect a method of manufacture for a modular compartment assembly is described. the method includes receiving a base, connecting a first sidewall to a first end of the base, wherein the first sidewall extends orthogonal to the base, connecting a second sidewall to a second end of the base, wherein the second sidewall extends orthogonal to the base and wherein the first sidewall and the second sidewall are located on opposing ends of the base and connecting a top wall parallel to the base, wherein the first sidewall is connected to the top wall at a first end and the second sidewall is connected to the top wall at a second end, the top wall having an activity mat. The method further includes placing at least one mobility module on a surface of the base, wherein the at least one mobility module extends in a direction opposite the first sidewall, creating a compartment area, the compartment area configured to receive at least one modular tool partition, and receiving at least one modular block located on an outer surface of the modular compartment assembly, the at least one modular block comprising at least one engagement feature and wherein the at least one modular block is removably attached to the outer surface of the modular compartment assembly.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exemplary embodiment of a modular compartment assembly;

FIGS. 2A-B are exemplary embodiments of an extended modular compartment assembly and a compact modular compartment assembly respectively;

FIGS. 3A-C are one or more exemplary embodiments of a modular tool partition;

FIGS. 4A-4D are one or more exemplary embodiments of a modular blocks; and

FIG. 5 is a flow diagram of a method of manufacture of a modular compartment assembly.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to modular compartment assemblies and methods of manufacture. In an embodiment, modular compartment assembly includes a base, a first sidewall, a second sidewall, a top wall, a compartment area and a modular block. In another embodiment, modular compartment assembly further includes a compartment hanger and one or more modular tool partitions.

Aspects of the present disclosure can be used to configure a compartment based on a particular requirement. Aspects of the present disclosure can also be used to charge one or more tools and collapse a compartment for mobile use.

Aspects of the present disclosure allow for customization of a compartment through the removing and replacement of one or more components. Exemplary embodiments illustrating aspects of the present disclosure are described below in the context of several specific examples.

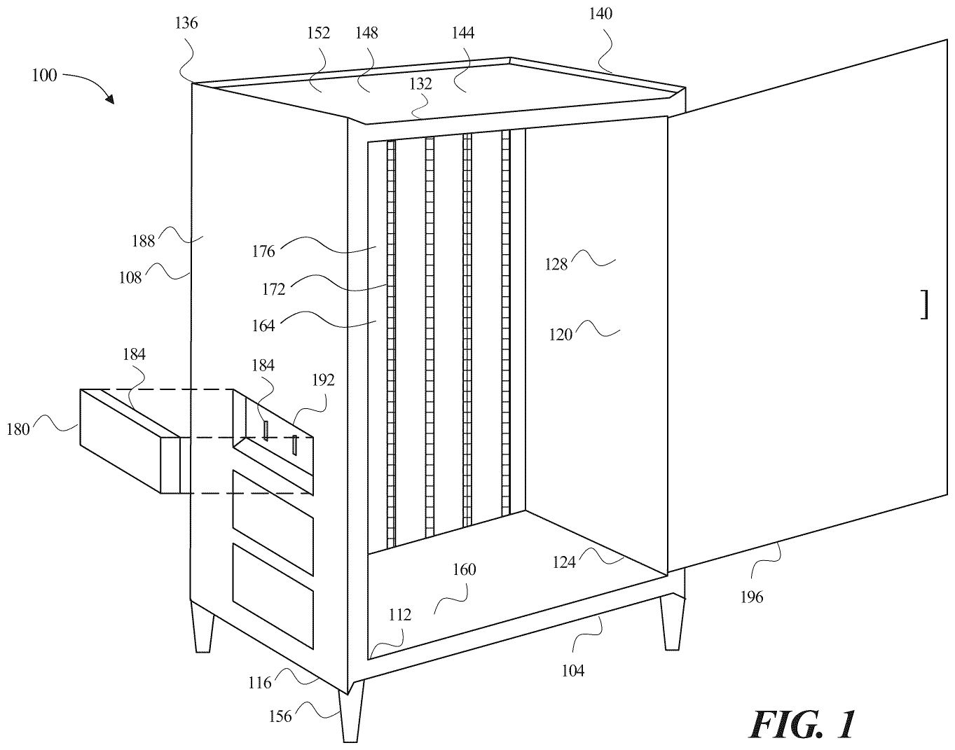

Referring now to FIG. 1, a modular compartment assembly 100 is described. Modular compartment assembly 100 includes a base 104. “Base,” for the purposes of this disclosure, is a structural element configured to provide support at a bottom of a modular compartment assembly 100. Base 104 may be configured to provide structural support for modular compartment assembly 100. In some cases, base 104 may include one or more materials. One or more materials, may include, but is not limited to, wood, metal, glass, plastic, carbon fiber, a carbon fiber composition, a composition of one or more materials and the like. In some cases, one or more materials may be comprised of a pliable material and/or a non-pliable material. In some cases, base 104 may be comprised of a hollow core. A hollow core may allow for a decrease in weight in modular compartment assembly 100. In some cases, a hollow core may allow for transmission of cables and/or other components through the hollow core. In some cases, hollow core may allow for the transmission of electrical cables through one section of base 104 to another section. In some cases, the electrical cable may transmit electricity to one or more areas of base 104.

With continued reference to FIG. 1, modular compartment assembly 100 includes a first sidewall 108 located at a first end of base 112 and extending orthogonal to base 104. “Sidewall” for the purposes of this disclosure is a structural element configured to provide support on a left or right side of modular compartment assembly. In some cases, first sidewall 108 may be fixedly attached to base 104. In some cases, first sidewall 108 may include one or more materials as described above. In some cases, first sidewall 108 may extend orthogonally to base 104 wherein first sidewall 108 may extend in a direction perpendicular or substantially perpendicular to base 104. In some cases, a first end of first sidewall 116 is connected to a first end of base 112. In some cases, first sidewall 108 may be removably attached to base 104 through one or more mating mechanisms. In some cases, one or more mating mechanisms may include screws, bolts, snap lock mechanisms, twist lock mechanisms and the like. In some cases one or more mating components may include male grooves that ae configured to be inserted into a receiving female receiving groove. Groove may include a tongue and groove, a half lap, a rabbet joint, a biscuit joint, a dowel joint, a dado going, an ordinary male groove and the like. In some cases, first sidewall 108 and/or any other structural elements may be fixedly attached to modular compartment assembly. Fixedly attached may include the use of one or more adhesives, the use of nails, welding one or more structural components together, riveting, stitching and the like.

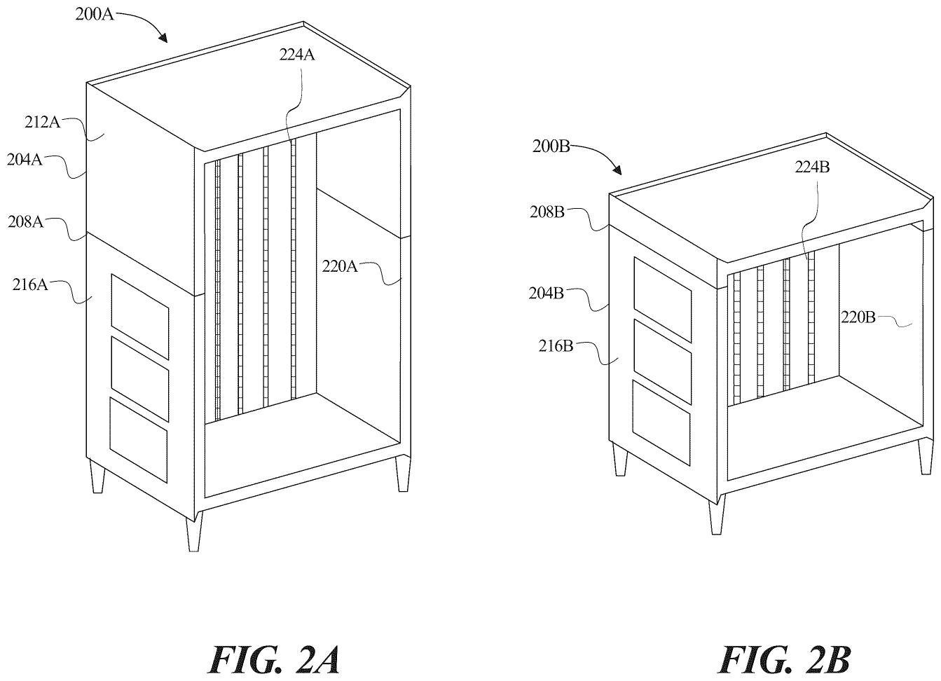

Referring now to FIG. 2A-B, an extended modular compartment assembly 200A and a compact modular compartment assembly 200B is described. In some cases, first sidewall 204A-B may include a telescoping feature 208A-B wherein the telescoping feature 208A-B may allow for conversion of extended modular compartment assembly 100 into compact modular compartment assembly 100 and vice versa. “Telescoping feature,” for the purposes of this disclosure, is a feature that allows for extension or retraction of one or more components of modular compartment assembly 100. In some cases, first sidewall 108 may include a top half 212A-B and a bottom half 216A-B wherein the top half 212A-B may contain dimensions suitable to insert top half 212A-B into bottom half 216A-B. In some cases, top half 212A-B may contain a smaller length and width wherein the smaller length and width may allow for insertion of top half 212A-B into bottom half 216A-B. In some cases, telescoping feature 208A-B may allow for extension and/or retraction of one or more walls within modular compartment assembly 100. In some cases, telescoping feature 208A-B may allow for reducing the height of modular compartment assembly 100. In some cases, telescoping feature 208A-B may allow for varying a height associated with modular compartment assembly 100. For example, a user may wish to increase the height of modular compartment assembly 100 in situations in which a user has more tools that may need to be placed within modular compartment assembly 100. In contract, a user may wish to reduce the height or volume of modular compartment assembly 100 when a user does not require the increase in space. In some cases, modular compartment assembly 100 may be configured for portability, wherein portability allows a user to move modular compartment assembly 100 from one location to another. In some cases, telescoping feature 208A-B may further allow for ease of transport, wherein modular compartment assembly 100 may fit within a vehicle in a compact version in contract to the extended version. In some cases, telescoping feature 208A-B may include a locking mechanism wherein the locking mechanism is configured to lock top half 212A-B and bottom half 216A-B in variable positions. In some cases, telescoping feature 208A-B may include springs to prevent contraction of the top half 212A-B int to the bottom half 216A-B and/or to assist with extension of modular compartment assembly 100. In some cases, first sidewall 108 may include telescoping feature 208A-B, top half 212A-B and/or bottom half 216A-B. In some cases, telescoping feature 208A-B may include one or more securement mechanisms, wherein the security mechanism is configured to secure the top half 212A-B and the bottom half 216A-B in one or more positions. In some cases, one or more components with modular compartment assembly 100 may include a telescoping feature 208A-B. In some cases, modular compartment assembly 100 may include more than one telescoping features 208A-B wherein more than one telescoping features 208A-B may allow for compaction and/or extension of modular compartment assembly 100.

Returning to FIG. 1, a “tool” for the purposes of this disclosure is any object that is used to carry out a particular function. A tool may include but is not limited to, cooking utensils (e.g. spoon, ladle, pot, pans, lids, an eggbeater, a whisk, a measuring cup and the like), construction tools (e.g. screwdriver, a drill, a saw, a chain saw, screws, measuring tape, tape, glue, adhesives, leveler and the like), tailoring tools (e.g. scissors, sewing string, measuring tape, cloth, sewing needle, sewing machine, stitching machine and the like), computer related tools (e.g. laptop computer, a virtual headset, a smart watch, a smart tablet, a smartphone and the like), office related tools (e.g. paper, tape, pens, pencils, highlighters, sticky notes, staplers, staples and the like), plumping related tools (plunger, drain auger, wrench and the like) and any other tools that may service a function.

Referring now to FIG. 1, modular compartment assembly 100 includes a second sidewall 120 located at a second end of base 124 and extending orthogonal to the base 104, wherein the first sidewall 108 and the second sidewall 120 are located on opposing ends of base 104. In some cases, second sidewall 120 may be consistent with first sidewall 108. In some cases, second sidewall 120 may include a telescoping feature (as shown in FIG. 2). In some cases, second sidewall 120 may be located on an opposing end of base 104, such as a second end of base 124. In some cases, a first end of second sidewall 120 may be located substantially next to a second end of base 124. In some cases, second sidewall 120 may be positioned perpendicular to base 104 to an extend in the first direction of sidewall. In some cases, first sidewall 108 and second sidewall 120 may contain similar dimensions such as length, width, and height.

With continued reference to FIG. 1, second sidewall 120 may contain a magnetized surface 128. magnetized surface 128 may be configured to hold one or more metal tools, such as a metal spoon, a metal wrench and the like. magnetized surface 128 may be located on any portion of second sidewall 120. In some cases, first sidewall 108 may contain magnetized surface 128. In some cases, any portion of modular compartment assembly 100 may contain magnetized surface 128. In some cases, magnetized surface 128 may be configured to secure and/or hold one or more tools between use, during use and after use. In some cases, magnetized surface 128 may be configured to hold one or more tools within or around modular compartment assembly 100.

With continued reference to FIG. 1, modular compartment assembly 100 includes a top wall 132 situated parallel to base 104. In some cases, first sidewall 108 is connected to top wall 132 at a first end of top wall 136 and second sidewall 120 is connected to top wall 132 at a second end of top wall 140. “Top wall” for the purposes of this disclosure is a structural element configured to provide support at a top of a modular compartment assembly. In some cases, first end of top wall 136 and second end of top wall 140 may be located on opposing ends. In some cases, top wall 132 may be comprised of one or more materials as described above. In some cases, top wall 132 may be removably attached to modular compartment assembly 100. In some cases, top wall 132 may include a hollow core, wherein the hollow core may allow for the placement of cables and/or wires through top wall 132. In some cases, the cables or wires may be configured to provide electrical energy to one or more components on or within modular compartment assembly 100. In some cases, the cables or wires may be configured to provide electrical energy to one or more tools that are not mechanically connected to modular compartment assembly 100. This may include, but is not limited to a smart phone, a computer, an electrical power tool and the like.

With continued reference to FIG. 1, top wall 132 includes an activity mat 144. “Activity mat,” for the purposes of this disclosure, is a surface that is configured to facilitate the secure placement of one or more tools without damage to assembly 100. As a non-limiting example, activity mat 144 may be configured to provide an easily accessible surface that may allow a user to place the tools or objects they are using. Continuing the example, a user may place a drill on activity mat 144 when the user needs to place down the drill for a moment. In some cases, activity mat 144 may include a pliable material such as silicone or a sponge like material that may be compressed when a tool is placed on it. In some cases, the pliable material may be configured to facilitate the placement of heavy tools and minimize any damage that may occur to the tools when they are placed on activity mat 144. In some cases, the pliable material may prevent slipping between a tool and activity mat 144. In some cases, activity mat 144 allow for placement of one or more tools wherein a user may place the tools during an activity. An activity may be configured to hold and/or secure cooking utensils, wherein a user may desire to place cooking utensils on activity mat 144 during cooking. An activity may further include an activity associated with one or more power tools wherein a user may place the one or more power tools on activity mat 144 between uses. In some cases, activity mat 144 may include a magnetized surface 128 wherein the magnetized surface 128 is configured to hold one or more magnetic tools and minimize slipping between activity mat 144 and the tool. In some cases, activity mat 144 may include a wireless charging mat 148. “Wireless charging mat,” for the purposes of this disclosure, is a device that allows for transmission of electrical energy through inductive charging. For example, activity mat 144 may be configured to charge a smartphone having wireless charging capabilities. In another non-limiting example, wireless charging mat 148 may be configured to charge one or more tools having wireless charging capabilities. This may include but is not limited to, smart phone, power tools and/or any other electronic devices. In some cases, wireless charging mat 144 may include one or more coils (such as copper coils) whereby power is passed through the coils to generate an electromagnetic field. When a wireless charging device comes into contact with the electromagnetic field, the electromagnetic field generates an electrical current within the device to create an oscillating magnetic field. The oscillating magnetic field allows for a current to pass through to the device and charge the device. In some cases, charging mat may include a cable to receive electrical energy from a power source. The cable may include a USB cable, or any other wiring capable of receiving electrical energy. In some cases, the coils within activity mat may be housed within a material such as silicone or plastic. In some cases, the housing may protect the coils within activity mat from damage and/or harm to another. “Power tools” for the purposes of this disclosure is a tool that is driven by electrical power. Power tool may include an electrical drill, an electrical nail gun and the like. In some cases, activity mat 144 may allow for charging of a tool between use. As a non-limiting example, activity mat 144 may charge a power tool between use when the power tool is placed on activity mat 144. In some cases, activity mat 144 may facilitate the charging of one or more electrical tools. In some cases, activity mat 144 may be powered through one or more cables within modular compartment assembly 100. In some cases, power may be supplied from a power source. In some cases, the power source may be contained directly within modular compartment assembly 100. In some cases, modular compartment assembly 100 may be electrically connected to a power source, such as a socket, and configured to transmit electrical energy from the power source to activity mat 144.

With continued reference to FIG. 1, activity mat 144 may be removably connected to modular compartment assembly 100. “Removably connected” for the purposes of this disclosure refers to the capability of attaching and removing one or more components from each other without destruction of the one or more components. For example, two components nailed two components nailed together may be fixedly attached as removal of the nail may cause damage to the components. In contract, two components may be removably connected when the components can be removed without damage, such as through a click lock mechanism In some cases, modular compartment assembly 100 may be configured to receive differing activity mats 144 based on the intended use of a user. For example, a user may place an activity mat 144 having a wireless charging mat 148 when the user desires to charge one or more objects. However, a user may place a different activity mat 144 such as one ideal for cooking tools when the user is cooking. In some cases, activity may be located on an outer surface of top wall 152. In some cases, activity mat 144 may be magnetically connected to top wall 132. In some cases, activity mat 144 may be fixedly attached to top wall 132.

With continued reference to FIG. 1, modular compartment assembly 100 includes at least one mobility module 156. “Mobility module” for the purposes of this disclosure is a component configured to provide support to modular component assembly by contacting a floor or ground. In some cases, mobility module 156 may include a leg wherein modular compartment assembly 100 may be supported by legs. In some cases, mobility modules 156 may include wheels wherein the wheels may allow for movement of modular compartment assembly 100 from one location to another. In some cases, the wheels may include a locking mechanism configured to prevent rotations of the wheels. The locking mechanisms, may include but are not limited to, caster locking mechanisms, friction wheel locks, stoppers and the like. In an embodiment, the locking mechanism may allow for the modular compartment assembly 100 to be stationary when desired or in use, and mobile when the modular compartment assembly 100 is to be moved from one location to another. In some cases, mobility modules 156 may be removably attached to base 104. In some cases, mobility modules 156 may be detached form modular compartment assembly 100 when a user desires to place modular compartment assembly 100 in one predetermined area. In some cases, mobility module 156 may be removably attached wherein a user may remove mobility module 156 from modular compartment assembly 100 based on the intended use of modular compartment assembly 100 and replace mobility module with a stationary support such as legs. For example, a user may place legs in lieu of mobility module 156 when the user wishes to leave modular compartment assembly 100 in one area whereas a user may place a mobility module 156 having wheels when the user intended to move modular compartment assembly 100 from one location to another. In some cases, mobility module 156 may be folded along an axis wherein in a folded state, modular compartment assembly 100 may be prevented from moving whereas in an extended stage modular compartment assembly 100 may be able to move. In some cases, the folding feature may allow for the addition of height to modular compartment assembly 100 when desired.

With continued reference to FIG. 1, at least one mobility modules 156 is located on a surface of base 160 and extends in a direction opposite the first sidewall 108. In some cases, mobility module 156 may extend at a 180-degree angle in relation to first sidewall 108. In some cases, mobility module 156 may be placed on surface of base 160 and underneath first sidewall 108. In

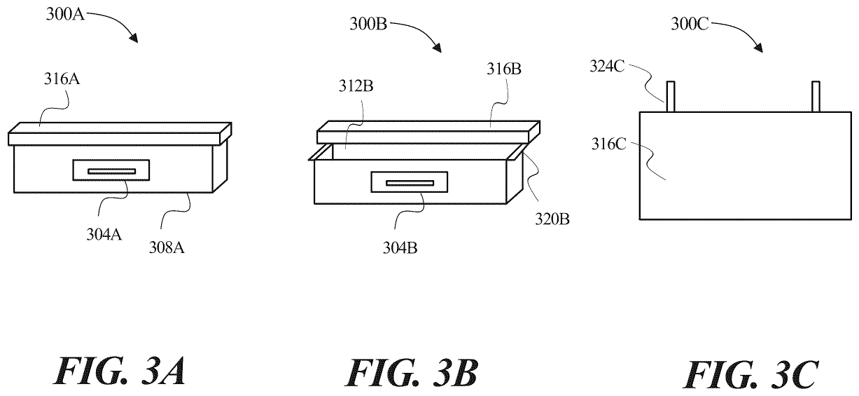

With continued reference to FIG. 1, modular compartment assembly 100 further includes a compartment area 164. “Compartment area,” for the purposes of this disclosure, is a cavity within modular compartment assembly 100 that is configured to house one or more tools. compartment area 164 is configured to receive at least one modular tool partition. “Modular tool partition” (as shown in FIG. 3), for the purposes of this disclosure, is a component configured to hold and separate one or more tools. for example, modular tool partition may be a surface or a drawer that may secure one or more tools. In some cases, modular tool partition may include a removable drawer, wherein the removable drawer may be used to hold one or more tools. “removable,” for the purposes of this disclosure, refers to the capability of separating one or more components without causing damage to either component. For example, a drawer may be removable from a dresser whereas a wall of the dresser may not be removable if the walls are nailed together. In some cases, modular compartment assembly 100 may be configured to hold one or more modular tool partitions. In some cases, each modular tool partition may be configured to hold similar tools. For example, a first modular tool partition may be configured to hold similar tools such as ladles, knives, spoons, etc. whereas a second modular tool partition may be configured to hold measuring cups, measuring spoons, etc. In some cases, modular tool partition may be removably attached to modular compartment assembly 100, wherein modular tool partition may be removed and placed on activity mat 144. In some cases, a user may desire to remove modular tool partition and use similar tools during a particular activity. As a result, activity may be configured to hold modular tool partition wherein a user may access the tools on modular tool partition during the activity. In some cases, a user may desire to replace a first modular tool partition with a second modular tool partition after use of the tools within first modular tool partition. In some cases, activity mat 144 may be configured to rigidly hold modular tool partition in place. In an embodiment, activity mat 144 may contain one or more mating mechanisms configured to mate with one or more mating mechanisms modular tool partition and secure modular tool partition during an activity. Modular tool partition will be described in greater detail below such as in FIG. 3.

With continued reference to FIG. 1, compartment area 164 may further include one or more compartment hangers 172. “Compartment hanger” for the purposes of this disclosure is a component configured to secure modular tool partition within compartment. In some cases compartment hanger 172 may include a rack or hooks wherein the rack or hooks are configured to mate within one or more mating mechanism on modular tool partitions and configured hold one or more modular tool partitions. In some cases, compartment hanger 172 may include one or more mating mechanisms configured to mate with one or more mating mechanisms on modular tool partition. In some cases, compartment hanger 172 may be configured to hold one or more modular tool partitions of varying sizes. In some cases, compartment hanger 172 may allow for the combination of one or more differing modular tool partitions within compartment area 164. In some cases, compartment hanger 172 may extend vertically on a back wall 176 of modular compartment assembly 100. In some cases, modular tool partition may connect to compartment hanger 172 along the length of back wall 176. In some cases, compartment area 164 may be configured to hold modular tool partitions of varying sizes. In some cases, compartment area 164, may include compartment hangers 172 located on first sidewall 108 and/or second sidewall 120. In some cases, compartment hanger 172 may include one or more magnetics, one or more hooks, one or more twist lock mechanisms, one or more snap lock mechanisms, hook-and-loop fasteners, VELCRO, and the like. In some cases, compartment area 164 may be configured to hold one or more modular tool partitions of varying sizes longitudinally or laterally within compartment area 164. In some cases, compartment hanger 172 may be removably attached to back wall 176. In an embodiment, a user may desire to remove compartment hanger 172 from compartment area 164. In some cases, compartment hanger 172 may be modular wherein a user may be able to switch a particular compartment hanger 172 with another compartment hanger 172 based the intended use of modular compartment assembly 100. In some cases, compartment area 164 may include more than one compartment hangers 172 wherein the more than one compartment hangers 172 may be configured to hold multiple modular tool partitions and/or provide structural rigidity to one or more modular tool partitions.

With continued reference to FIG. 1, compartment area 164 and/or modular compartment assembly 100 may be configured to hold one or more handheld power tools. “Handheld power tool,” for the purposes of this disclosure, is an electrical tool that may be gripped and held by the user during its intended use. Handheld power tool may include a handheld electric drill, a nail gun, an electric stapler, a Dremel and the like. In some cases, handheld power tool may include any electrical tool that may be gripped by a user during its intended use.

With continued reference to FIG. 1, modular compartment assembly 100 may further include at least one modular block 180. “Modular block,” for the purposes of this disclosure, is a removable component of modular compartment assembly 100 that provides a particular functionality for modular compartment assembly 100. For example, modular block 180 may be configured to provide power to modular compartment assembly 100 in situations wherein modular compartment assembly 100 may require power. In another non-limiting example, modular block 180 may provide for hangers or hooks in situations where modular compartment assembly 100 may require additionally hangers or hooks and/or in situations where a user may benefit from a hook located on a particular area of modular compartment assembly 100. In some cases, modular compartment assembly 100 may be configured to receive a plurality of modular blocks 180 wherein each modular block 180 may perform a particular functionality. In some cases, modular block 180 may provide power to modular compartment assembly 100 by providing an electrical connection between modular compartment assembly 100 and a power source (e.g. such as a wall socket). In some cases, modular block 180 may include a battery or battery pack wherein the battery may provide electrical energy through modular compartment assembly 100. In some cases, modular block 180 may include at least one electrical output features such as USB outlets, USB-C, a type A electrical socket, a type B electrical socket and the like. An “electrical output feature” for the purposes of this disclosure is a device or system that is capable of providing electrical energy to another tool or device. Electrical output feature may include multiple configurations as described above, such as USB-C in order to provide electrical energy to another device. In some cases, modular block 180 may contain an inverter, wherein modular block 180 may be configured to receive an alternating current and convert into a direct current. In some cases, modular block 180 may further include wall outlet, wherein the wall outlet is configured to be plugged into a wall socket. “Wall outlet” also known as “power outlet,” for the purposes of this disclosure, is a device installed within the wall of a structure that is configured to provide electrical energy from a central power source. In some cases, wall outlet may include a type-A outlet configured to receive Type-A electrical devices, a type-B outlet configured to provide energy to type-B electrical devices and the like.

With continued reference to FIG. 1, modular block 180 contains at least one engagement feature 184. An “engagement feature” is a characteristic of a component that allows the component to be mated with another component. In some cases, engagement feature 184 may include a male groove configured to be received by a corresponding female groove. In some cases, engagement feature 184 may include a magnetized element configured to be connected to a metal. Additionally or alternatively, engagement feature 184 may contain a metal configured to be connected to a magnetized surface. In some cases, engagement feature 184 may allow for an electrical connection between two components. In some cases, engagement feature 184 may allow for electrical connection between modular block 180 and modular compartment assembly 100. In some cases, engagement feature 184 may include an electrical plug and/or outlet configured to provide transmit electrical energy along engagement feature 184. In some cases, engagement feature 184 may further include VELCRO, hook-and-loop fastener, and the like. In some cases, engagement feature 184 may allow for attachment of modular block 180 to modular compartment assembly 100. In some cases, modular compartment assembly 100 contains engagement feature 184 wherein engagement feature 184 on modular compartment assembly 100 may be mated with engagement feature 184 of modular block 180.

With continued reference to FIG. 1, modular block 180 is removably attached to an outer surface of modular compartment assembly 188. In some cases, outer surface of modular compartment assembly 188 may include an indent 192, wherein modular block 180 is configured to be fitted within indent 192. In some cases, modular block 180 may be substantially flush with outer surface of modular block 180 assembly. In some cases, modular block 180 may be located on first sidewall 108, second sidewall 120, back wall 176 and the like. Modular block 180 is explained in further detail below.

With continued reference to FIG. 1, In some cases, modular compartment assembly 100 may include a door 196. Door 196 may be configured to close modular compartment assembly 100. In some cases, door 196 may be hingidly attached to one or more sidewalls within modular compartment assembly 100. “Hingidly attached” for the purposes of this disclosure refers to a configuration wherein two components are attached together through a hinge. A hinge may include a pivot hinge, a ball bearing hinge, a barrel hinge, a concealed hinge, an overlay hinge, a piano hinge, a strap hinge and the like. In some cases the hinge may allow for opening and closing of modular compartment assembly through door 196. In some cases, the hinge may allow for partial opening and partial closing of modular compartment assembly. In some cases, the hinge may allow for opening of modular compartment assembly without having to remove door 196. In some cases, door 196 may include a door locking mechanism wherein compartment area 164 within modular compartment assembly 100 may be inaccessible when door 196 is locked. In some cases, door 196 may be removably attached to modular compartment assembly 100 wherein door 196 may be removed as desired. In some cases, modular compartment and/or door 196 may include a hinge as described above to allow for opening and closing of modular compartment assembly without removing door 196. In some cases, door 196 may be removed prior to compaction of modular compartment assembly 100 as described in FIG. 2. In some cases, door 196 may be configured to prevent one or more tools within compartment area 164 from coming in contact with one or more outside elements (e.g. rain, sand, dust, etc.).

Returning to FIGS. 2A-B, extended modular compartment assembly 200A and compact modular compartment assembly 200B are illustrated. In some cases, modular compartment assemblies 200A-B may include telescoping feature 208A-B as described above. In some cases, first sidewall 204A-B, second sidewall 220A-B and/or back wall 224A-B may include telescoping feature 208A-B. In some cases, compartment hanger (as described above) may contain telescoping feature 208A-B wherein compartment hanger may be compacted. In some cases, compartment hanger may extend and collapse wherein compartment hanger may be configured to extend and collapse in relation to the corresponding walls. In some cases, extended modular compartment 200A assembly may be compacted through the use of engagement feature and transformed into compact modular compartment assembly 200A. In some cases, extended modular compartment assembly 200A is compact modular compartment assembly 200B in an extended configuration.

Referring now to FIGS. 3A-C, one or more embodiments of modular tool partition 300A-C are illustrated. In some cases, modular tool partition 300A-C may include a handle 304A-B wherein the handle 304A-B may be gripped in order to grip modular tool partition 300A-C. In some cases, modular tool partition 300A-C may include a drawer 308A-B, wherein the drawer 308A-B may be configured to hold one or more tools. In some cases, the drawer 308A-B may include a cavity 312B wherein tools may be placed and secured within the cavity 312B. In some cases, modular tool partition 300A-C may include a tray 316A-C. Tray 316A-C may be configured to hold one or more tools. In some cases, tray 316A-C may contain one or more securements mechanisms, such as tie down rings, wherein the tie down rings may be configured to hold one or more tools in place. In some cases, tray 316A-C may be configured to temporarily hold one or more tools while they are in use. In some cases, tray 316A-C may be configured to cover one or more tools within drawer 308A-B. In some cases, tray 316A-C may be configured to protect tools from one or more outside elements.

With continued reference to FIGS. 3A-C, modular tool partition 300A-C may include a sliding rail system 320B. Sliding rail system 320B (sometimes known as linear rail and track systems) may be configured to allow for linear extension of drawer 308A-B and/or tray 316A-C from modular tool partition 300A-C. In some cases, sliding rail system 320B may allow for ease of access of one or more tools within modular tool partition 300A-C. In some cases, sliding rail system 320B may allow for an opening of drawer 308A-B, and/or linear extension of tray 316A-C from within modular compartment assembly 100. In some cases, modular tool partition 300A-C may consist only of a tray 316A-C wherein the tray 316A-C may be configured to hold one or more tools. In some cases, both tray 316A-C and drawer 308A-B, may contain sliding rail system 320B wherein tray 316A-C may extend a first distance from modular compartment assembly 100 and drawer 308A-B may extend a second distance from tray 316A-C. In some cases, tray 316A-C may extend from compartment area 164 and may contain the same function as activity mat 144 as described above.

With continued reference to FIGS. 3A-C, in some cases, drawer 308A-B and/or tray 316A-C may contain one or more electrical output features. For example, tray 316A-C and/or drawer 308A-B may contain a USB port, a type A socket, a type B socket, and the like. In some cases, tray 316A-C and/or drawer 308A-B may be configured to charge one or more rechargeable devices while they are stored on or within modular tool partition 300A-C. In some cases, tray 316A-C and/or drawer 308A-B may include a wireless charging pad wherein the wireless charging pad may be configured to wirelessly (through inductive charge) charge one or more wireless charging devices.

With continued reference to FIGS. 3A-C, in some cases, modular tool partition 300A-C may contain more than one size. In some cases, modular tool partition 300A-C may be long enough to cover a distance from first sidewall 108 to second sidewall 120. In some cases, modular tool several may be small enough wherein more than one modular tool partitions 300A-C may laterally fit between first sidewall 108 and second sidewall 120. In some cases, Modular tool partition 300A-C may contain a height enough to cover the distance between top wall 132 and base 104. In some cases, several modular tool partition 300A-Cs may fit longitudinally between top wall 132 and base 104. In some cases, modular tool partitions 300A-C of varying sizes may congruently be placed within modular compartment assembly 100. In some cases, a user may seek to place modular tool partition 300A-Cs of varying sizes within modular compartment assembly 100. In an embodiment, a smaller modular tool partition 300A-C may be configured to hold smaller tools and/or a limited number of tools whereas a larger modular tool partition 300A-C may be configured to hold larger tools and/or more tools. In some cases, compartment hanger 172 may allow for the placement of one or more modular tool partition 300A-Cs laterally or longitudinally within compartment area 164. In some cases, compartment hanger 172 may allow for the placement of modular tool partition 300A-C in various areas along compartment area 164. With continued reference to FIG. 1, modular tool partition 300A-C may contain a securement feature 324C wherein securement feature 324C is configured to secure modular tool partition 300A-C to compartment hanger 172. In some cases, securement feature 324C may allow for securement of modular tool partition 300A-C to modular compartment assembly 100. In some cases, securement feature 324C may contain one or more electrical connection wherein modular tool partition 300A-C may be electrically connected to modular compartment assembly 100. In some cases, security feature may include one or more metal components configured to receive electrical energy. In some cases, securement feature 324C may facilitate the transmission of power to modular tool partition 300A-C. In some cases, securement feature 324C may allow for removable attachment of modular tool partition 300A-C to modular compartment assembly 100. In some cases, securement feature 324C may include a hook wherein the hooks is configured to hang on compartment hanger 172. In some cases, security feature may include one or more magnets. In some cases, securement feature 324C may contain one or more locking mechanisms as described in this disclosure.

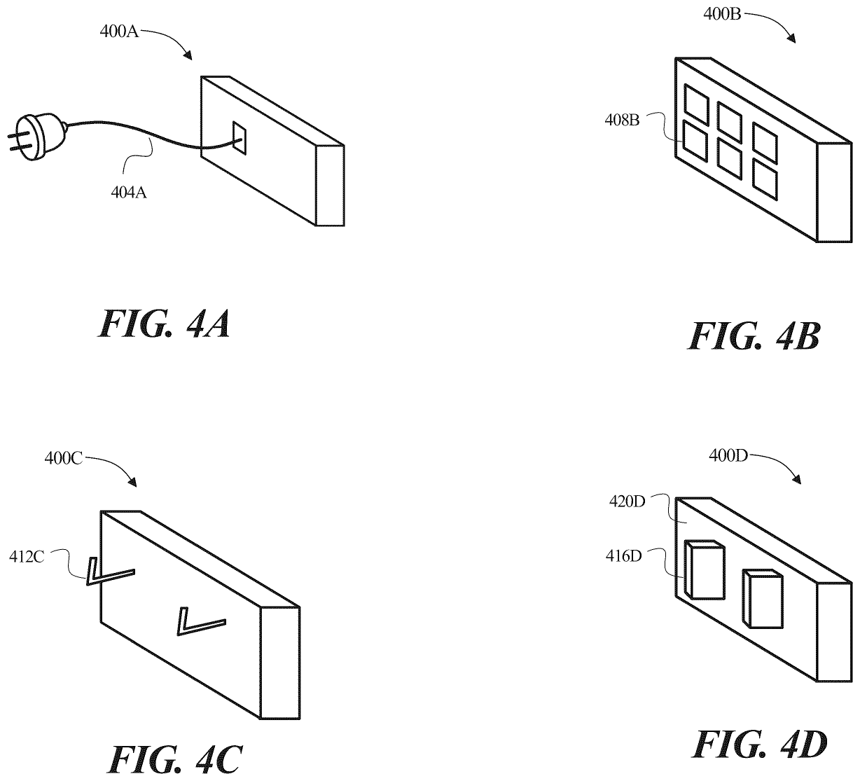

Referring now to FIG. 4A-C, one or more exemplary embodiments of modular block 400A-D is illustrated. In an embodiment, modular block 400A-D may include a wall outlet 404A wherein the wall outlet 404A may be configured to be plugged into a wall socket and receive electrical energy. In some cases, modular block 400A-D may receive electrical energy through wall outlet 404A and provide electrical energy to one or more components of modular compartment assembly 100. In some cases, modular block 400A-D may be electrically connected to modular compartment assembly 100 wherein modular block 400A-D may provide electrical energy to modular compartment assembly 100 through the electrical connection. The electrical connection may include the connection of wires, the connection of two metals, the transmission of electrical energy through induction and the like. In some cases, modular block 400A-D may include a rechargeable power bank. The power bank may include one or more batteries and/or battery packs. The power bank may be charged through wall outlet 404A. In some cases, modular block 400A-D may include an inverter that is configured to convert an alternating current into a direct current, such as an alternating current received from wall outlet 404A. In some cases, the power bank may provide electrical energy to modular compartment assembly 100 when modular compartment assembly 100 is not connected to a power source through wall outlet 404A. In some cases, modular block 400A-D may include an electrical output feature 408B. The electrical output feature 408B may include electrical output through USB-C, USB, type A, Type B and any other electrical output means. In some cases, electrical output feature 408B may allow for the powering or charging of one or more tools while the tools are not stored within modular compartment assembly 100. In some cases, modular block 400A-D may contain one or more electrical output feature 408Bs wherein each electrical output feature 408B may be configured to power a different device or tool. For example, a first electrical output feature 408B may include an electrical output of 5 volts, whereas a second electrical output feature 408B may include an electrical output of 10 Volts. In some cases, modular block 400A-D may include a speaker. In some cases, the speaker may include a Bluetooth speaker wherein a user may wirelessly connect to the Bluetooth speaker. In some cases, modular block 400A-D may include a rack configured to hold one or more tools. In some cases, modular block 400A-D may further include a bottle opener, a staple remover, a tray, a magnetized surface 128, and any other features that may facilitate the use of one or more tools. In some cases, modular block 400A-D may further include a hanger 412C. Hanger 412C may be configured to hold one or more tools while the tool is outside of modular compartment area 164. In some cases, hanger 412C may be configured to hold a tool between use. In some cases, hanger 412C may be configured to hang tools for quick access. In some cases, tools that are used more often may be placed on hanger 412C rather than within modular compartment assembly 100. In some cases, modular tool block may further include an engagement feature 416D. Engagement feature 416D may be located on a back surface 420D of modular block 400A-D. In some cases, engagement feature 416D may be configured to mate with an engagement feature 416D on modular compartment assembly 100. In some cases engagement feature 416D may allow for connection of modular block 400A-D to modular compartment assembly 100. In some cases engagement feature 416D may provide for electrical connection between modular block 400A-D and modular compartment assembly 100. In some cases engagement feature 416D may facilitate the transmission of electrical energy from modular block 400A-D to modular compartment assembly 100. In some cases, engagement feature 416D may include a conductive material in order to facilitate the connection between engagement feature 416D and modular compartment assembly 100. In some cases where modular block 400A-D does not contain any electrical components, engagement feature 416D may include nonconductive material to prevent the transmission of energy to or from modular block 400A-D. In some cases modular block 400A-D may include a magnetic surface. In some cases, modular block 400A-D may include a tray configured to hold one or more objects. In some cases, the tray may be magnetized.

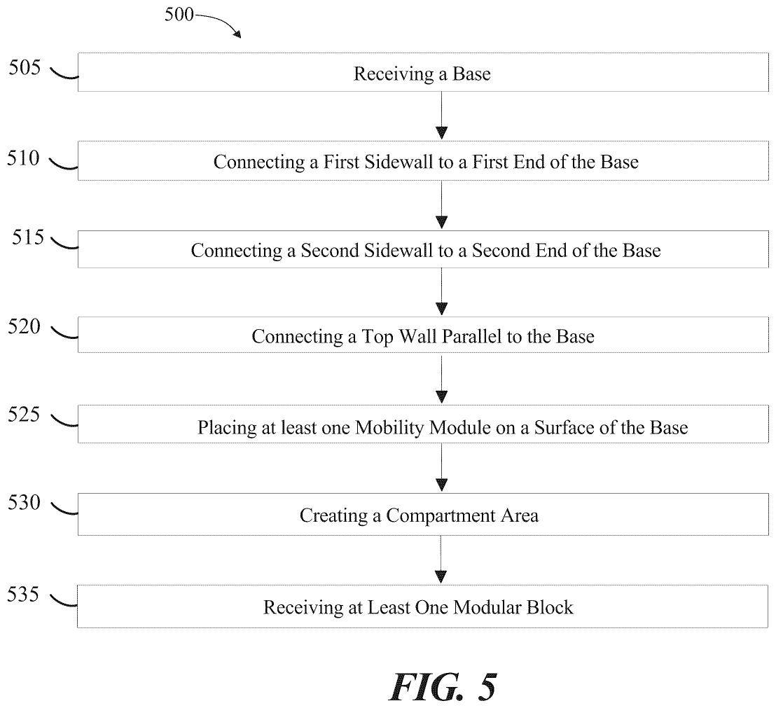

Referring now to FIG. 5, a method 500 of manufacture of a modular compartment assembly is described. At step 505 method 500 includes receiving a base. This may be implemented within reference to FIGS. 1-4 and without limitations.

With continued reference to FIG. 5, at step 510 method 500 includes connecting a first sidewall to a first end of the base, wherein the first sidewall extends orthogonal to the base. In some cases, first sidewall includes a telescoping feature. This may be implemented within reference to FIGS. 1-4 and without limitations.

With continued reference to FIG. 5, at step 515 method 500 includes connecting a second sidewall to a second end of the base, wherein the second sidewall extends orthogonal to the base and wherein the first sidewall and the second sidewall are located on opposing ends of the base. In some cases, the second sidewall includes a magnetized surface, the magnetized surface configured to magnetically hold one or more metal tools.

With continued reference to FIG. 5, at step 520 method 500 includes connecting a top wall parallel to the base, wherein the first sidewall is connected to the top wall at a first end and the second sidewall is connected to the top wall at a second end, the top wall having an activity mat. In some cases, activity mat includes a wireless charging mat. This may be implemented within reference to FIGS. 1-4 and without limitations.

With continued reference to FIG. 5, at step 525 method 500 includes placing at least one mobility module on a surface of the base, wherein the at least one mobility module extends in a direction opposite the first sidewall. Ins some cases, the at least one mobility module includes removable legs. In some cases, the at least one mobility module includes removable wheels. This may be implemented within reference to FIGS. 1-4 and without limitations.

With continued reference to FIG. 5, at step 530 method 500 includes creating a compartment area, the compartment area configured to receive at least one modular tool partition. In some cases, the at least one modular tool partition is electrically connected to a power source.

With continued reference to FIG. 5, at step 535, method 500 includes receiving at least one modular block located on an outer surface of the modular compartment assembly, the at least one modular block having at least one engagement feature and wherein the at least one modular block is removably attached to the outer surface of the modular compartment assembly. In some cases, the at least one modular block includes a wall outlet. In some cases, at least one modular block includes at least one electrical output feature. In some cases, the modular compartment assembly is configured to hold one or more handheld power tools. This may be implemented within reference to FIGS. 1-4 and without limitations.

1. A modular compartment assembly, the modular compartment assembly comprising:
a base;
a first sidewall located at a first end of the base and extending orthogonal to the base;
a second sidewall located at a second end of the base and extending orthogonal to the base, wherein the first sidewall and the second sidewall are located on opposing ends of the base;
a top wall situated parallel to the base, wherein the first sidewall is connected to the top wall at a first end of the top wall and the second sidewall is connected to the top wall at a second end of the top wall, the top wall comprising an activity mat, wherein the activity mat is made of a sponge material that is compressed when a tool is placed on it and is configured to minimize damage to the modular compartment assembly;
at least one mobility module located on a surface of the base and extending in a direction opposite of the first sidewall;
a compartment area comprising at least one compartment hanger extending vertically on a back wall, wherein the compartment area is configured to receive at least one modular tool partition; and
at least one modular block removably attached to an outer surface of the modular compartment assembly, the at least one modular block comprising at least one engagement feature, wherein the at least one engagement feature comprises a metal configured to be connected to a magnetized surface to allow for attachment of the at least one modular block to the modular compartment assembly.

2. The modular compartment assembly of claim 1, wherein the first sidewall comprises a telescoping feature configured to vary a height of the modular compartment assembly.

3. The modular compartment assembly of claim 1, wherein at least one mobility module comprises removable legs.

4. The modular compartment assembly of claim 1, wherein the at least one mobility module comprises removable wheels.

5. The modular compartment assembly of claim 1, wherein the activity mat comprises a wireless charging mat.

6. The modular compartment assembly of claim 1, wherein the at least one modular block comprises a wall outlet.

7. The modular compartment assembly of claim 1, wherein the at least one modular block comprises at least one electrical output feature.

8. The modular compartment assembly of claim 1, wherein the modular compartment assembly is configured to hold one or more handheld power tools.

9. The modular compartment assembly of claim 1, wherein the at least one modular tool partition is electrically connected to a power source.

10. The modular compartment assembly of claim 1, wherein the second sidewall comprises a magnetized surface, the magnetized surface configured to magnetically hold one or more metal tools.

11. A method of manufacture of a modular compartment assembly, the method comprising:
receiving a base;
connecting a first sidewall to a first end of the base, wherein the first sidewall extends orthogonal to the base;
connecting a second sidewall to a second end of the base, wherein the second sidewall extends orthogonal to the base and wherein the first sidewall and the second sidewall are located on opposing ends of the base;
connecting a top wall parallel to the base, wherein the first sidewall is connected to the top wall at a first end of the top wall and the second sidewall is connected to the top wall at a second end of the top wall, the top wall comprising an activity mat, wherein the activity mat is made of a sponge material that is compressed when a tool is placed on it and is configured to minimize damage to the modular compartment assembly;
placing at least one mobility module on a surface of the base, wherein the at least one mobility module extends in a direction opposite of the first sidewall;
creating a compartment area comprising at least one compartment hanger extending vertically on a back wall, wherein the compartment area is configured to receive at least one modular tool partition; and
receiving at least one modular block removably attached to an outer surface of the modular compartment assembly, the at least one modular block comprising at least one engagement feature, wherein the at least one engagement feature comprises a metal configured to be connected to a magnetized surface to allow for attachment of the at least one modular block to the modular compartment assembly.

12. The method of claim 11, wherein the first sidewall comprises a telescoping feature configured to vary a height of the modular compartment assembly.

13. The method of claim 11, wherein at least one mobility module comprises removable legs.

14. The method of claim 11, wherein the at least one mobility module comprises removable wheels.

15. The method of claim 11, wherein the activity mat comprises a wireless charging mat.

16. The method of claim 11, wherein the at least one modular block comprises a wall outlet.

17. The method of claim 11, wherein the at least one modular block comprises at least one electrical output feature.

18. The method of claim 11, wherein the modular compartment assembly is configured to hold one or more handheld power tools.

19. The method of claim 11, wherein the at least one modular tool partition is electrically connected to a power source.

20. The method of claim 11, wherein the second sidewall comprises a magnetized surface, the magnetized surface configured to magnetically hold one or more metal tools.
